(19) United States
(12) Patent Application Publication
(10) Pub. No.: US 2023/0208171 A1
(43) Pub. Date: Jun. 29, 2023

(54) Electrical Device having Electromechanical Battery Interfaces

(71) Applicant: Robert Bosch GmbH, Stuttgart (DE)

(72) Inventors: Rainer Glauning, Leinfelden-Echterdingen (DE); Andreas Strasser, Rudersberg (DE); Markus Reichstadt, Dettenhausen (DE)

(21) Appl. No.: 18/145,165

(22) Filed: Dec. 22, 2022

(30) Foreign Application Priority Data
Dec. 23, 2021 (DE) 10 2021 214 995.2

(51) Int. Cl. H02J 7/00

(52) U.S. Cl. CPC H02J 7/0063; H02J 7/0024; H02J 7/00041

(57) ABSTRACT

An electrical device includes a control or regulating circuit and a plurality of electromechanical battery interfaces configured to supply the electrical device with a maximum permissible operating voltage using at least one exchangeable battery pack, which is releasably accommodated by the electromechanical battery interfaces. The electromechanical battery interfaces are configured such that exchangeable battery packs of at least two different voltage classes can be accommodated. The control or regulating circuit electrically connects several exchangeable battery packs of a lower voltage class in series and/or in parallel such that a resulting battery voltage does not exceed the maximum permissible supply voltage.

This application claims priority under 35 U.S.C. § 119 to patent application no. DE 10 2021 214 995.2, filed on Dec. 23, 2021 in Germany, the disclosure of which is incorporated herein by reference in its entirety.

The disclosure relates to an electrical device comprising a control or regulating circuit and comprising a plurality of electromechanical battery interfaces, as disclosed herein.

### Background

Battery-operated devices are available in a wide variety of power classes depending on their intended use. There are hand-held power tools in lower power classes, for instance, that are operated with 10.8 V (nominally often also referred to as 12 V) or 14.4 V, whereas, in the medium to higher power classes, devices in voltage classes of 18 V, 36 V, 54 V, or also 72 V are predominantly used. The voltage values result from the connection (parallel or series) of the battery cells being used. The battery cells are preferably configured as lithium-based battery cells, e.g. Li-ion, Li-Po, Li-metal or the like, with a cell voltage of 3.6 V. To ensure the longest possible operating times and the shortest possible pause times, in particular in commercial applications, exchangeable batteries or exchangeable battery packs have become well-established in many electrical devices. Said batteries or battery packs are releasably connected to one another in a force and/or form-locking manner via corresponding battery interfaces on the exchangeable battery packs and the electrical devices.

A system comprising a plurality of battery-operated power tools, a plurality of exchangeable battery packs and at least one battery charger is known from WO 2018/119256, wherein the plurality of exchangeable battery packs includes at least a first exchangeable battery pack for a first voltage class and at least a second exchangeable battery pack for the first and a second voltage class. The plurality of battery-operated power tools includes a first battery-operated power tool comprising a battery interface for the first exchangeable battery pack of the first voltage class and for the second exchangeable battery pack for operation in the first voltage class. The plurality of battery-operated power tools further includes a second battery-operated power tool comprising a battery interface for the second exchangeable battery pack for operation in the second voltage class. A user can therefore use one of the exchangeable battery packs of the system both for a battery-operated power tool of the first voltage class and for a battery-operated power tool of the second voltage class.

A battery-operated device comprising a combination or multislot battery interface for electromechanically coupling at least one exchangeable battery pack is known from EP 3 517 253 A1, wherein the multislot interface is configured in such a way that either a first exchangeable battery pack with a higher first voltage or at least two second exchangeable battery packs with a lower second voltage can be coupled via the multislot interface in order to supply the battery-operated device with electrical voltage.

DE 20 2017 105 258 U1 reveals a further alternative for the use of exchangeable battery packs of different power or voltage classes on a battery-operated power tool, wherein there an adapter is used, which connects a plurality of exchangeable battery packs of a lower voltage class in such a way that they can be operated on the power tool with an integer multiple of the lower voltage class.

Known also from EP 3 661 004 A1 is a system comprising at least one exchangeable battery pack, a battery-operated power tool, an adapter for such a power tool and a charger for charging the at least one exchangeable battery pack. Several exchangeable battery packs can be operated on the power tool or the adapter in series or in a parallel connection, for instance, depending on the power requirement.

An object of the disclosure is to provide an electrical device comprising a plurality of electromechanical battery interfaces which enables more flexible, simple and secure use of exchangeable battery packs of different voltage classes compared to the prior art.

### SUMMARY

The disclosure relates to an electrical device comprising a control or regulating circuit and comprising a plurality of electromechanical battery interfaces for supplying the electrical device with a maximum permissible operating voltage by means of at least one exchangeable battery pack which can be releasably accommodated by the electromechanical battery interfaces, wherein the electromechanical battery interfaces are designed in such a way that exchangeable battery packs of at least two different voltage classes can be accommodated. To achieve the stated object, it is provided that the control or regulating circuit of the electrical device electrically connects several exchangeable battery packs of a lower voltage class in series and/or in parallel in such a way that their resulting battery voltage does not exceed the maximum permissible supply voltage. This results in the advantage that a user can operate the electrical device very flexibly, simply and securely with exchangeable battery packs of different voltage classes that are already in his possession or currently available to him, in particular fully charged. Depending on the application, the user can also decide which exchangeable battery packs he would like to use. For instance, he can use several exchangeable battery packs of a higher or the highest possible voltage class if a longer period of use is needed, whereas, when the focus is on a lower overall weight, the use of exchangeable battery packs of lower voltage classes is preferred.

Electrical devices in the context of the disclosure should, for example, be understood to mean battery-operated power tools for machining workpieces by means of an electrically driven insert tool. The power tool can be configured both as a hand-held power tool and as a stationary electric machine tool. Typical power tools in this context are hand or bench drills, screwdrivers, percussion drills, hammer drills, breakers, agitators, planers, angle grinders, orbital sanders, polishing machines, circular saws, table saws, crosscut saws and jigsaws, or the like. However, battery-operated lamps and gardening and building equipment (e.g. lawnmowers, lawn trimmers, pruning saws, power cultivators and trenchers, robotic breakers, drills and excavators or the like), household appliances (e.g. vacuum cleaners, mixers, electric grills, etc.) and electric vehicles (marine, land, and air) are considered to be electrical devices as well. Even an adapter that adapts a plurality of exchangeable battery packs to a single battery interface of a battery-operated consumer should be understood to be an electrical device within the meaning of the disclosure.

The battery voltage of an exchangeable battery pack is typically a multiple of the voltage of a single battery cell and results from the connection (parallel or in series) of the individual battery cells. A battery cell is typically configured as a galvanic cell which has a structure in which one cell pole comes to lie at one end and a further cell pole comes to lie at an opposite end. The battery cell in particular has a positive cell pole at one end and a negative cell pole at an opposite end. The battery cells are preferably configured as lithium-based battery cells, e.g. Li-ion, Li-Po, Li-metal or the like. However, the disclosure can also be applied to exchangeable battery packs with NiCd, NiMH cells or other suitable types of cells. In common Li-ion battery cells with a cell voltage of 3.6 V, voltage classes of 3.6 V, 7.2 V, 10.8 V, 14.4 V, 18 V, 36 V, etc., for example, are produced. A battery cell is preferably configured as an at least substantially cylindrical round cell, wherein the cell poles are disposed at ends of the cylinder shape. However, the disclosure is not dependent on the type and design of the battery cells used, but can be applied to any exchangeable battery packs and battery cells, e.g. also pouch cells or the like in addition to round cells.

A “releasable accommodation” of the exchangeable battery pack should in particular be understood to be a connection between the electromechanical battery interfaces of the exchangeable battery pack and the electrical device that can be released and produced without tools, i.e. by hand. It should also be noted that the configuration of the electromechanical battery interfaces of the electrical devices and the associated receptacles for the force-locking and/or form-locking releasable connection of the exchangeable battery packs for the different voltage classes are not intended to be the subject matter of this disclosure.

The battery interfaces of the exchangeable battery packs of a voltage class are typically designed in such a way that they are only compatible with the corresponding battery interface of an electrical device of the same voltage or power class. This often makes it necessary for users of electrical devices of different voltage or power classes to purchase and keep available a corresponding variety of different exchangeable battery packs. A person skilled in the art will select a suitable embodiment for the battery interface depending on the power or voltage class of the electrical device and/or the exchangeable battery pack. The embodiments shown in the embodiment examples should therefore be understood as mere examples.

In a further development of the disclosure, it is provided that the control or regulating circuit connects a plurality of exchangeable battery packs of the highest possible voltage class in parallel. This ensures that the maximum permissible supply voltage of the electrical device is not exceeded so as to avoid possible damage due to an overvoltage. Thus, even when using several exchangeable battery packs of the highest possible voltage class, a user does not have to worry about damaging the electrical device.

However, parallel connection of exchangeable battery packs can result in a flow of equalizing currents between exchangeable battery packs with different states of charge. These equalizing currents can also negatively affect the service life of the exchangeable battery packs and the efficiency of the electrical device. In order to avoid a specific protection circuit that prevents these equalizing currents, it is provided in an alternative embodiment that the control or regulating circuit controls the plurality of exchangeable battery packs of the highest possible voltage class sequentially or alternately in such a way that only one of the exchangeable battery packs provides energy to the battery-operated device at any given time.

The control or regulating circuit can furthermore also control a plurality of exchangeable battery packs of different voltage classes in a parallel connection sequentially or alternately in such a way that the resulting battery voltage of all exchangeable battery packs of the same voltage class does not exceed the maximum permissible supply voltage. This particularly advantageously allows the simultaneous and very flexible use of different exchangeable battery packs depending on availability, without the user having to worry about combining them.

The control or regulating circuit records a temperature value measured in each exchangeable battery pack and controls the exchangeable battery packs sequentially or alternately as a function of the measured temperature values in such a way that it switches from an exchangeable battery pack the measured temperature value of which exceeds a temperature limit value to an exchangeable battery pack the measured temperature value of which does not exceed the temperature limit value. Overheating of an exchangeable battery pack can thus effectively be avoided without negatively affecting the performance of the electrical device. Dynamic or alternating switching between the exchangeable battery packs particularly advantageously maximizes the running time of the electrical device without the risk of individual exchangeable battery packs overheating. Dynamic or alternating switching of exchangeable battery packs within the same voltage class, defined current limit values and/or defined internal resistance limit values is conceivable in this context as well, because the temperature behavior is dependent on these additional parameters.

Additionally or alternatively, the control or regulating circuit records the battery voltage of each exchangeable battery pack and controls the exchangeable battery packs sequentially or alternately as a function of the measured battery voltages in such a way that it switches from an exchangeable battery pack the measured battery voltage of which falls below a minimum voltage limit value to an exchangeable battery pack the measured battery voltage of which does not fall below the minimum voltage limit value. Such a consideration of the state of charge over the battery voltage enables timely switching from a weak exchangeable battery pack to an exchangeable battery pack having sufficient power reserves.

In a further development of the disclosure, it is provided that the control or regulating circuit controls the exchangeable battery packs in such a way that their total power does not fall below a preset minimum power for the battery-operated device. This ensures the most efficient possible operation of the electrical device and avoids increased wear on the exchangeable battery packs and in particular on insert tools, such as drills, chisels, grinding wheels, saw blades, etc. Additionally or alternatively, the control or regulating circuit blocks the battery-operated device when the resulting battery voltage of all possible connection variations of the exchangeable battery packs falls below a minimum voltage limit value. This makes it possible to avoid the electrical device being operated with a power that is clearly too weak, for example because too few exchangeable battery packs of a lower voltage class have been inserted or plugged into the battery interfaces by the user.

To make the use of the exchangeable battery packs of different voltage classes as flexible as possible for the user, the electrical device comprises at least two electromechanical battery interfaces for exchangeable battery packs of the highest possible voltage class and at least two electromechanical battery interfaces for exchangeable battery packs of a lower voltage class.

The electrical device particularly advantageously comprises at least two combination battery interfaces, wherein one combination interface consists of a plurality of electromechanical battery interfaces for exchangeable battery packs of at least two different voltage classes such that exchangeable battery packs of different voltage classes cannot be accommodated in it at the same time. A mixed operation of exchangeable battery packs of different voltage classes can therefore only take place via several combination interfaces of the electrical device, wherein it is easily ensured that the user does not use combinations of exchangeable battery packs of different voltage classes that are hazardous or harmful to the electrical device.

To provide the user with information about the switching behavior of the control or regulating circuit of the electrical device or about the state of the exchangeable battery packs, a display that shows the exchangeable battery packs currently being controlled, in particular the measured temperature values and/or battery voltages thereof, is provided on the electrical device. If the electrical device is preferably embodied as a power tool, a lamp, gardening or building equipment, a smaller electric vehicle or a household appliance with a corresponding power requirement, it is particularly advantageous if the exchangeable battery packs of the highest possible voltage class are 36 V exchangeable battery packs and the exchangeable battery packs of the lower voltage classes are 12 V and/or 18 V exchangeable battery packs. Such exchangeable battery packs have proven to be particularly advantageous for these electrical devices in terms of their performance, their weight and their size.

### BRIEF DESCRIPTION OF THE DRAWINGS

The disclosure will be explained in the following using the figures as examples, wherein identical reference signs in the figures indicate identical components having an identical function.

FIG. 1 shows a block diagram of an electrical device according to the disclosure which is embodied as an electrical consumer and comprises a plurality of electromechanical battery interfaces for supplying the electrical consumer by means of at least one exchangeable battery pack which can be detachably accommodated by the electromechanical battery interfaces in a first embodiment,

FIG. 2 shows a block diagram of an electrical device according to the disclosure which is embodied as an adapter for an electrical consumer and comprises a plurality of electromechanical battery interfaces for supplying the electrical consumer by means of at least one exchangeable battery pack which can be detachably accommodated by the electromechanical battery interfaces in a second embodiment,

FIG. 3A shows a schematic illustration of the electrical device according to the disclosure in the form of a circular table saw comprising two electromechanical battery interfaces of a highest possible voltage class and two electromechanical battery interfaces of a lower voltage class in a third embodiment without inserted exchangeable battery packs,

FIG. 3B shows the circular table saw of FIG. 3A with instered exchangeable battery packs,

FIG. 4A shows a schematic illustration of a combination battery interface for the electrical device in a perspective view without inserted exchangeable battery packs,

FIG. 4B shows the combination battery interface of FIG. 4A in a side view without inserted exchangeable battery packs,

FIG. 5A shows a schematic illustration of a combination battery interface for the electrical device in a perspective view with inserted exchangeable battery packs, and

FIG. 5B shows the combination battery interface of FIG. 5A in a side view with the inserted exchangeable battery packs.

### DETAILED DESCRIPTION

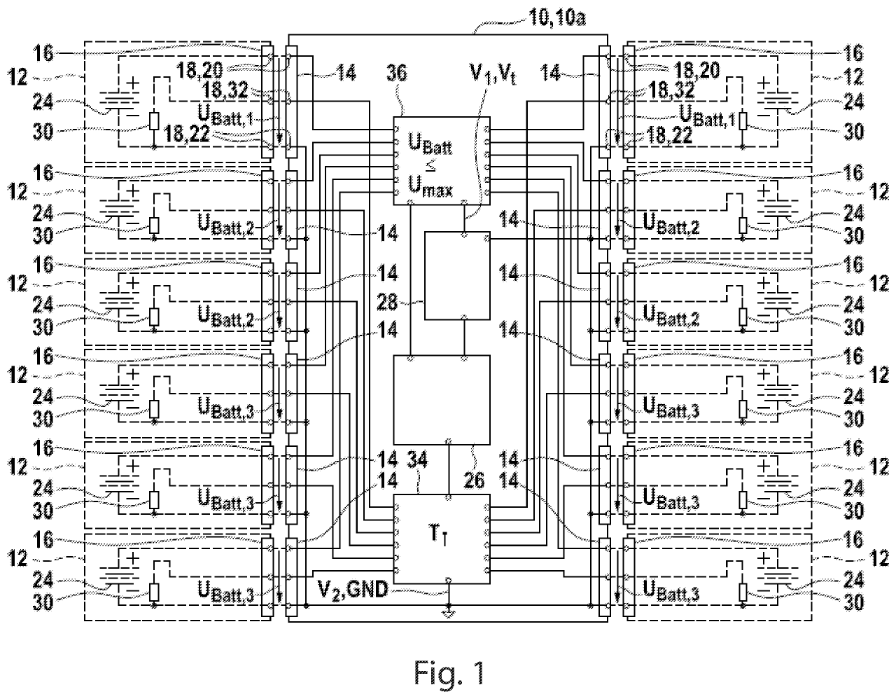

FIG. 1 shows a block diagram of an electrical device 10 embodied as an electrical consumer 10a, which can be supplied with energy via a plurality of N of exchangeable battery packs 12 of different voltage classes U_{Cl,n} (2≤n≤N). The exchangeable battery packs 12 are shown with dashed lines because they can optionally be connected to the electrical consumer 10a by a user depending on availability and state of charge. For this purpose, the electrical consumer 10a comprises a plurality I of a total of 12 electromechanical battery interfaces 14, which can be releasably connected to correspondingly compatible electromechanical interfaces 16 of the individual exchangeable battery packs 12 without tools. Two of the electromechanical battery interfaces 14 are configured in such a way that they are compatible with exchangeable battery packs 12 of a highest possible voltage class U_{Cl,1} of nominally 36 V, for example. Four others of the electromechanical battery interfaces 14 are configured in such a way that they are compatible with exchangeable battery packs 12 of a lower voltage class U_{Cl,2} of nominally 18 V, for example, and the remaining six electromechanical interfaces 14 can only accommodate exchangeable battery packs 12 of a further lower voltage class U_{Cl,3} of nominally 12 V, for example. The term “nominally” is intended to clarify that the actual battery voltages U_{Batt,i} of the individual exchangeable battery packs 12 can deviate from their voltage classes U_{Cl,n} depending on their state of charge and/or their cell topology. The number of battery interfaces 14 of the electrical consumer 10a should be understood as merely an example and is therefore not limiting to the disclosure. The same applies to the number and the nominal values of the voltage classes U_{Cl,n}. However, it is essential for the disclosure that both are provided in a plurality, i.e. n>1 and i>1, for the electrical device 10.

The mutually corresponding electromechanical battery interfaces 14 and 16 each comprise a plurality of electrical contacts 18, wherein a first of the electrical contacts 18 serves as an energy supply contact 20 which can be loaded with a first reference potential V₁, preferably a supply potential V₊, and a second of the electrical contacts 18 of the battery interfaces 14, 16 serves as an energy supply contact 22 which can be loaded with a second reference potential V₂, preferably a ground potential GND. Via the first and second energy supply contacts 20, 22, each exchangeable battery pack 12 can, on the one hand, be discharged by the electrical consumer 10a with a discharge current and, on the other hand, be recharged by a not depicted charger with a charge current. For the sake of clarity, only the electrical contacts 18 of the electromechanical battery interfaces 14, 16 for the exchangeable battery packs 12 of the highest possible voltage class U_{Cl,1} were provided with corresponding reference numbers in FIG. 1. These apply equally to the other electromechanical battery interfaces 14, 16.

The current strengths of the charge and the discharge current can differ significantly from one another. The discharge current in correspondingly designed electrical consumers 10 can be up to 10 times higher than the charge current of the charger. Despite these differences between the charge and the discharge current, the following discussion will refer only to a load current I. The phrase “can be loaded” is intended to clarify that, in particular in the case of an electrical device 10 that can be connected to at least one exchangeable battery pack 12, the potentials V+ and GND are not permanently present at the energy supply contacts 20, 22, but only after the electrical battery interfaces 14, 16 have been connected. The same applies to a discharged exchangeable battery pack 12 after connection to a charger. The exact configuration of the electromechanical interfaces 14, 16 depends on a variety of factors, for example the voltage class U_{Cl,n} or different manufacturer specifications. Thus, for example, it is also possible for more than two electrical contacts 18 to be provided for energy and/or data transmission between the exchangeable battery pack 12 and the electrical device 10 or the charger. Depending on the voltage class U_{Cl,n}, a different number of electrical contacts 18 is also conceivable as well. Mechanical coding is possible too, so that exchangeable battery packs 12 of a same voltage class U_{Cl,n} but a different power classes can only be accommodated by correspondingly compatible electromechanical battery interfaces 16. Since the exact configuration of the electromechanical interfaces 14, 16 is of only minor importance for the disclosure, this will not be discussed in further detail. Both a person skilled in the art and a user of the electrical device 10 will make the appropriate selection in this regard.

Each exchangeable battery pack 12 can comprise a plurality of energy storage cells 24 which can be operated in a series and/or parallel connection, wherein the series connection defines the battery voltage U_{Batt,i} of the individual exchangeable battery packs 12 which decreases across the energy supply contacts 20, 22, while a parallel connection of individual energy storage cells 24 primarily increases the capacity of an exchangeable battery pack 12. It is also possible to connect individual cell clusters consisting of parallel-connected energy storage cells 24 in series to achieve a specific battery voltage U_{Batt,i} of the exchangeable battery pack 12 while at the same time increasing the capacity. For common Li-ion energy storage cells 24 with a respective cell voltage U_{Cell} of 3.6 V, battery voltages U_{Batt,i} decrease from 10.8 V, 18 V and 36 V across the energy supply contacts 20, 22 in the present embodiment example. Depending on the number of parallel-connected energy storage cells 24 in a cell cluster, the capacity of common exchangeable battery packs 12 can be up to 12 Ah or more. However, the disclosure is not dependent on the design, voltage, power supply capability, etc. of the energy storage cells 24 used, but can be used for any exchangeable battery pack 12 and energy storage cells 24.

The electrical consumer 10a comprises a control or regulating circuit 26, which can, for example, be configured as an integrated circuit in the form of a microprocessor, ASIC, DSP, FPGA or the like. It is also conceivable that the control or regulating circuit 26 consists of several microprocessors or at least in part of discrete components with corresponding transistor logic. The control or regulating circuit 26 also comprises a preferably integrated memory for storing operating parameters of the connected exchangeable battery packs 12, such as the battery voltages U_{Batt,i}, the cell voltages U_{Cell} of the energy storage cells or clusters 24, a cell or battery pack temperature Tᵢ, the load current I or the like.

The control or regulating circuit 26 furthermore controls an electrical or electromechanical load 28 of the electrical consumer 10a connected to the first and second energy supply contacts 20, 22. For the sake of clarity, the load 28 is not shown in more detail. It can be configured as a power output stage, for example, that applies a pulse-width modulated signal to an electric motor to change its rotational speed and/or torque, which has a direct effect on the load current I of the exchangeable battery pack 12. The electric motor is used to drive an insert tool, for example, such as a drill, a chisel, a grinding wheel, a saw blade, etc. Any other power-converting load 28 is conceivable as well, however. Numerous variants of possible electrical or electromechanical loads 28 are known to the person skilled in the art, so this will not to be discussed in any further detail.

A temperature sensor 30 disposed in each exchangeable battery pack 12, which is preferably NTC-configured and in close thermal contact with at least one of the energy storage cells 24, is used to measure the cell or battery pack temperature Tᵢ of the respective connected exchangeable battery pack 12 or the energy storage cells 24. The thus measured temperature values Tᵢ are respectively transmitted via an electrical contact 18 of the electromechanical battery interfaces 14, 16 configured as a signal or data contact 32 to the electrical consumer 10a for evaluation by means of the control or regulating circuit 26 there. For this purpose, the electrical consumer 10a comprises a measuring circuit or a multiplexer 34, which records the individual temperature values Tᵢ of the exchangeable battery pack 12 connected to the electrical consumer 10a.

The control or regulating circuit 26 of the electrical consumer 10a now electrically connects the individual exchangeable battery pack 12 in series and/or in parallel by means of a selector 36 in such a way that their resulting battery voltage U_{Batt} does not exceed a maximum permissible supply voltage Uₘₐₓ (U_{Batt}≤Uₘₐₓ). A user of the electrical consumer 10a can therefore operate it very flexibly, simply and securely with exchangeable battery packs 12 of different voltage classes U_{Cl,n}, which are already in his possession or which are currently available to him, in particular charged. Depending on the application, the user can also decide which exchangeable battery packs 12 he would like to use. For example, he can use several exchangeable battery packs 12 of a higher or the highest possible voltage class U_{Cl,n} if a longer period of use is needed, whereas the use of exchangeable battery packs 12 of lower voltage classes U_{Cl,n} is preferred when the focus is on a lower overall weight and better handling.

The selector 36 can be configured as a transistor or relay network, which causes the individual exchangeable battery packs 12 to be connected in series and/or in parallel as a function of the control by the control or regulating circuit 26. Such power networks consisting of bipolar transistors, field effect transistors, IGBT and/or relays are known to the person skilled in the art, so this will not to be discussed in any further detail. The selector 36 can also be configured as an integrated power circuit with corresponding transistor topologies or the like.

To avoid exceedance of the maximum permissible supply voltage Uₘₐₓ when multiple exchangeable battery packs 12 of the highest possible voltage class U_{Cl,1} are used at the same time, the control or regulating circuit 26 only connects these exchangeable battery packs 12 in parallel. Therefore, for a maximum permissible supply voltage Uₘₐₓ of 36 V in the present embodiment example, two 36 V exchangeable battery packs 12 are connected in parallel. However, parallel connection of exchangeable battery packs 12 can result in a flow of equalizing currents between exchangeable battery packs 12 with different states of charge. These equalizing currents can negatively affect the service life of the exchangeable battery packs 12 and the efficiency of the electrical consumer 10a. It is therefore alternatively provided that the control or regulating circuit 26 controls the plurality of 36 V exchangeable battery packs 12 sequentially or alternately, so that only one of these exchangeable battery packs 12 provides energy to the electrical consumer 10a at any given time.

Even when several exchangeable battery packs 12 of lower voltage classes U_{Cl,2} and/or U_{Cl,3} are used at the same time, the control or regulating circuit 26 always connects these exchangeable battery packs 12 in such a way that their resulting battery voltage U_{Batt} does not exceed the maximum permissible operating voltage Uₘₐₓ of the electrical consumer 10a. However, unlike the exchangeable battery packs 12 of the highest possible voltage class U_{Cl,1}, the sufficient number of exchangeable battery packs 12 of the lower voltage classes U_{Cl,2} or U_{Cl,3} can be connected both in series and in parallel or in mixed operation. Thus, for a maximum permissible operating voltage Uₘₐₓ of 36 V in the present embodiment example, when using four 18 V exchangeable battery packs 12 at the same time, two can be operated in series and, in the event of an increased power requirement, these two series connections can be operated in parallel. A parallel connection of two 18 V connected in series and three 12 V exchangeable battery packs 12 connected in series, for example, is therefore possible as well. Here, too, to avoid equalizing currents, it can be useful to control the individual series connections of the exchangeable battery packs 12 and/or individual exchangeable battery packs 12 sequentially or alternately. This particularly advantageously allows the simultaneous and very flexible use of different exchangeable battery packs 12 depending on availability, without the user having to worry about combining them.

The control or regulating circuit 26 can control the exchangeable battery packs 12 sequentially or alternately as a function of the measured temperature values Tᵢ in such a way that it switches from an exchangeable battery pack 12, the measured temperature value Tᵢ of which exceeds a temperature limit value Tₘₐₓ to an exchangeable battery pack, the measured temperature value Tᵢ of which does not exceed the temperature limit value Tₘₐₓ. Overheating of an exchangeable battery pack 12 can thus effectively be avoided without negatively affecting the performance of the electrical consumer 10a. Such a dynamic or alternating switching between the exchangeable battery packs 12 makes it possible to maximize the running time of the electrical consumer 10a without the risk of individual exchangeable battery packs 12 overheating. Since the temperature behavior also depends, among other things, on the voltage class U_{Cl,n}, defined current limit values and/or internal resistance limit values, the dynamic or alternating switching of the exchangeable battery packs 12 can also be implemented as a function of these parameters.

The control or regulating circuit 26 records the battery voltages U_{Batt,i} of the connected exchangeable battery pack 12 by means of the selector 36 in order to be able to infer their respective state of charge. The control or regulating circuit 26 then controls the exchangeable battery packs sequentially or alternately as a function of the measured battery voltages U_{Batt,i} in such a way that it switches from an exchangeable battery pack 12, the measured battery voltage U_{Batt,i} of which falls below a minimum voltage limit value Uₘᵢₙ to an exchangeable battery pack 12, the measured battery voltage U_{Batt,i} of which does not fall below the minimum voltage limit value Uₘᵢₙ. Taking into account the state of charge thus makes it possible to enable timely switching from a weak exchangeable battery pack 12 to an exchangeable battery pack 12 having sufficient power reserves.

The control or regulating circuit 26 furthermore controls the exchangeable battery packs 12 in such a way that their total power P_{Batt} does not fall below a preset minimum power Pₘᵢₙ for the electrical consumer 10a. This ensures the most efficient possible operation of the electrical consumer 10a and avoids increased wear on the exchangeable battery packs 12 and in particular on insert tools used with the electrical consumer 10a configured as a power tool, such as drills, chisels, grinding wheels, saw blades, etc. Additionally or alternatively, the control or regulating circuit 26 blocks the electrical consumer 10a when the resulting battery voltage U_{Batt} of all possible connection variations of the exchangeable battery packs 12 falls below a minimum voltage limit value Uₘᵢₙ. This makes it possible to avoid the electrical consumer 10a being operated with a power that is clearly too weak, for example because too few exchangeable battery packs 12 of a lower voltage class U_{Cl,n} have been inserted or plugged into the electromechanical battery interfaces 14 by the user.

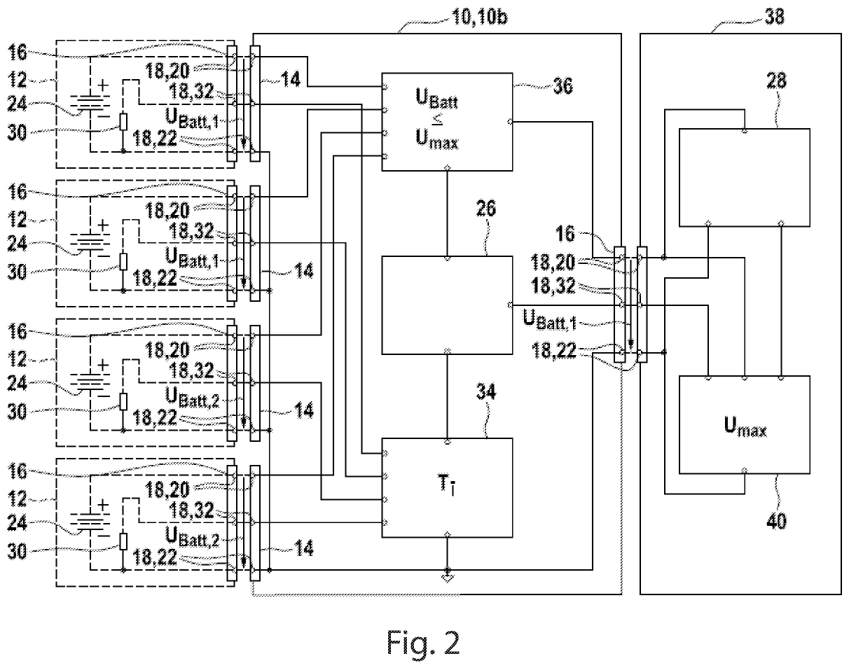

As already mentioned at the outset, the electrical device 10 can also be configured as an adapter 10b for a corresponding electromechanical battery interface 14 of a battery-operated consumer 38. Therefore, according to FIG. 2, it is not the adapter 10b itself, but rather the electrical consumer 38 that provides the electrical load 28. In addition to the plurality I of four electromechanical battery interfaces 14 for tool-free releasable connection to the exchangeable battery packs 12 of different voltage classes U_{Cl,n} shown in FIG. 2, the adapter 10b also comprises a further electromechanical battery interface 16, by means of which the adapter 10b itself can be releasably connected to the electromechanical battery interface 14 of the electrical consumer 38 without tools. The additional electromechanical battery interface 16 of the adapter 10b is preferably configured in such a way that it is identical to the electromechanical battery interface 16 of an exchangeable battery pack 12 of the highest possible voltage class U_{Cl,1}. The control or regulating circuit 26 of the adapter 10b and a control or regulating circuit 40 integrated in the battery-operated consumer 38 exchange the operating parameters already mentioned above via their signal or data contact 32. The signal or data contact 32 is also used to control the control or regulating circuit 26 of the adapter 10b by the control or regulating circuit 40 of the battery-operated consumer 38 in the manner already described with respect to FIG. 1. For example, the control or regulating circuit 40 of the battery-operated consumer 38 transmits its maximum permissible operating voltage Uₘₐₓ to the control or regulating circuit 26 of the adapter 10b, so that the latter can in turn control the selector 36 for the required connection of the exchangeable battery packs 12 connected to the adapter 10b.

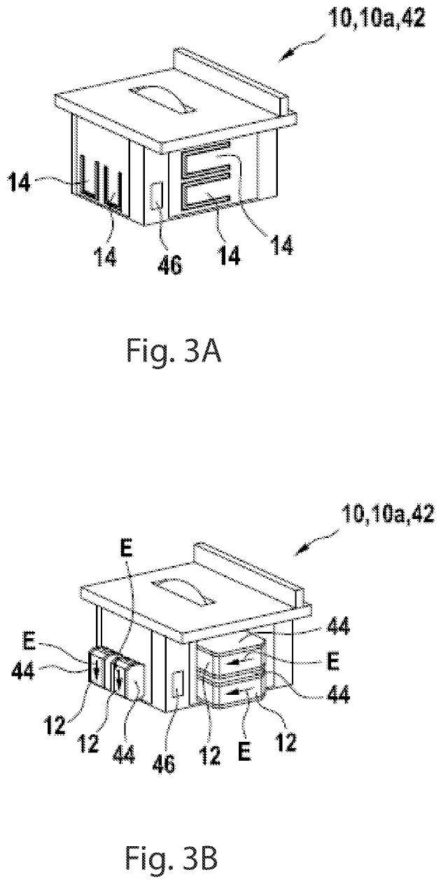

FIG. 3A shows a further embodiment example of an electrical consumer 10a according to the disclosure in the form of a circular table saw 42, which, like the adapter 10b according to FIG. 2, is equipped with two electromechanical battery interfaces 14 of a highest possible voltage class U_{Cl,1} and two electromechanical battery interfaces 14 of a lower voltage class U_{Cl,2}. The exchangeable battery packs 12 are conventional exchangeable battery packs with a housing 44, which, on a first side wall, comprises the electromechanical interface 16 for tool-free releasable connection to the battery interface 14 of the electrical device 10 and to a not depicted charger. By default, the circular table saw 42 is operated at a maximum permitted operating voltage Uₘₐₓ of 36 V. The two electromechanical battery interfaces 14 of the highest possible voltage class U_{Cl,1} are thus designed for 36 V exchangeable battery packs 12 and the two electromechanical battery interfaces 14 of the lower voltage class U_{Cl,2} are designed for 18 V exchangeable battery packs 12. If, as shown in FIG. 3B, all four exchangeable battery packs 12 have been inserted with their electromechanical interfaces 16 into the electromechanical interfaces 14 of the circular table saw 14 provided for this purpose in the respective insertion direction E, the control or regulating circuit 26 can control the selector 36 in accordance with the necessary power requirements or states of charge and/or temperature values as discussed above with respect to FIGS. 1 and 2. It is also possible that the control or regulating circuit 26 controls the selector 36 automatically in accordance with the exchangeable battery packs 12 inserted by the user in the described manner, but wherein the circular table saw 42 is blocked from further operation if its required minimum power Pₘᵢₙ or a required minimum voltage limit value Uₘᵢₙ is not achieved. The circular table saw 42 further comprises a display 46 which displays the exchangeable battery packs 12 currently being controlled, in particular the measured temperature values Tᵢ and/or battery voltages U_{Batt,i} thereof.

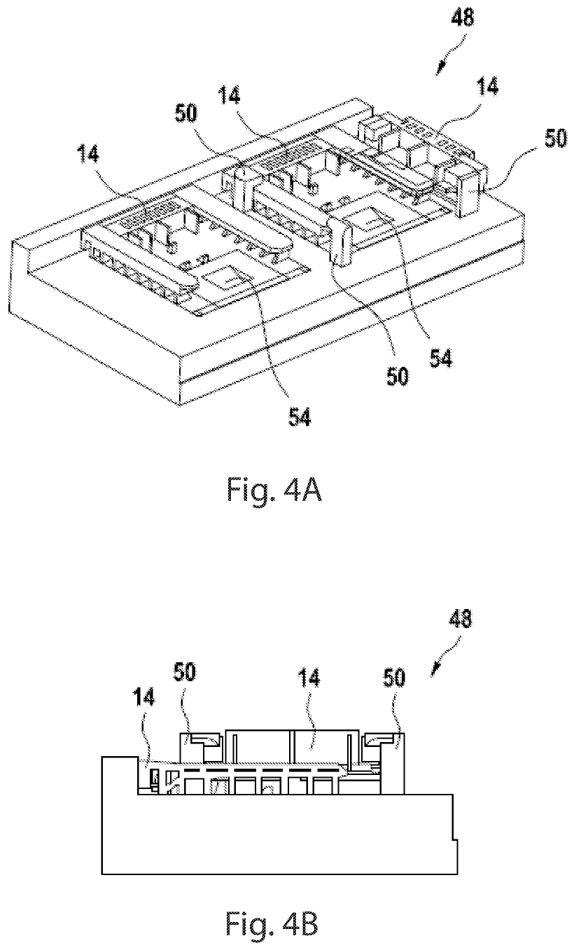

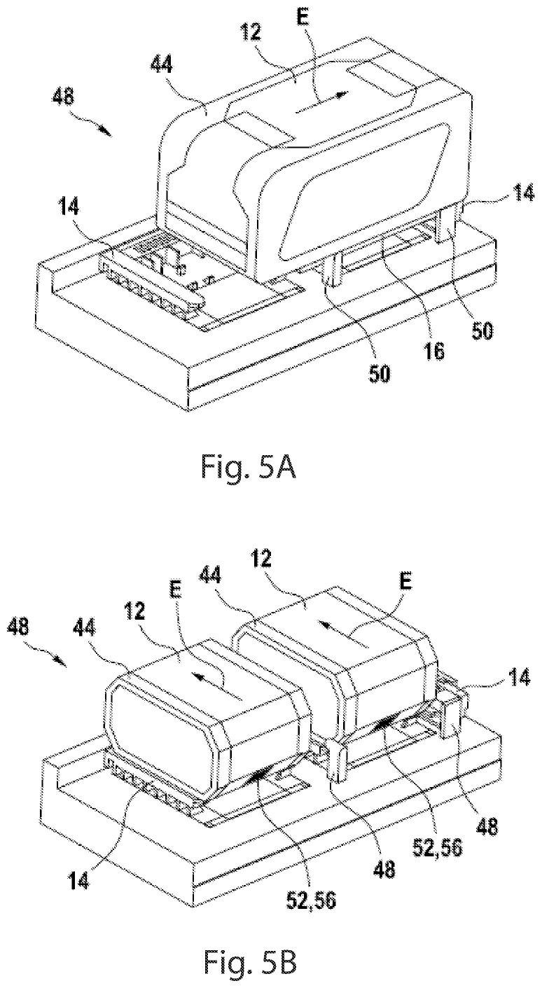

FIGS. 4A, 4B, 5A, and 5B show a combination battery interface 48 for the electrical device 10, which consists of a plurality of electromechanical battery interfaces 14 for exchangeable battery pack 12 of at least two different voltage classes U_{Cl,n} such that exchangeable battery packs 12 of different voltage classes U_{Cl,n} cannot be accommodated in it at the same time. The electrical device 10 preferably comprises at least two such combination battery interfaces 48. Each combination battery interface 48 comprises partially overlapping electromechanical battery interfaces 14 for exchangeable battery packs 12 of a highest possible voltage class U_{Cl,1} (e.g. 36 V) and at least one lower voltage class U_{Cl,2} (18 V), U_{Cl,3} (12 V).

In the shown embodiment example, the electromechanical battery interface 14 for the 36 V exchangeable battery pack 12 is disposed vertically offset and at right angles to the two adjacently positioned electromechanical battery interfaces 14 for the 18 V exchangeable battery packs 12. The electromechanical battery interfaces 14 for the exchangeable battery packs 12 of the two different voltage classes U_{Cl,1}, U_{Cl,2} are thus directly above one another in such a way that they block one another for the respectively accommodated exchangeable battery packs 12 of the other voltage class U_{Cl,2}, U_{Cl,1}. Due to the overlapping of the respective battery interfaces 14 at different levels, additional guide rails 50 for guiding and holding the electromechanical battery interface 16 of the 36 V exchangeable battery pack 12 are needed for the battery interface 14 for the 36 V exchangeable battery pack 12.

In the shown embodiment example, the 18 V exchangeable battery packs 12 each comprise a mechanical locking device 52 (see FIGS. 4A and 4B) for locking the form and/or force-locking releasable connection of their electromechanical battery interfaces 16 in a recess 54 of the battery interfaces 14 of the combination battery interface 48. Each locking device 52 comprises a spring-loaded pushbutton 56 which is operatively connected to a not depicted locking member of the 18 V exchangeable battery pack 12. Due to the springiness of the pushbutton 56 and/or the locking member, the locking device 52 automatically engages in the recess 54 of the associated battery interfaces 14 when the 18 V exchangeable battery packs 12 is inserted in the insertion direction E, as shown in FIGS. 5A and 5B. If a user pushes the pushbutton 56 in the insertion direction E when the 18 V exchangeable battery pack 12 is engaged, the locking is released and the user can remove or push the 18 V exchangeable battery pack 12 out of the battery interface 14 against the insertion direction E.

Unlike the 18 V exchangeable battery packs, the 36 V exchangeable battery pack 12 does not comprise a locking device on the battery pack side. In this case, the locking of the 36 V exchangeable battery pack 12 is instead implemented via the battery interface 14 itself. It should be noted, however, that the locking of the exchangeable battery pack 12 should be understood as merely an example and it is therefore immaterial to the disclosure whether locking on the electrical device 10 takes place via the exchangeable battery pack 12 and/or via the battery interface 14. Locking of the exchangeable battery packs 12 can also be omitted entirely.

Lastly, it should be noted that the disclosure is not limited to the shown embodiment examples according to the figures. Thus, in particular the electromechanical battery interfaces 14, 16 of the exchangeable battery packs 12 and the electrical device 10 as well as those of the combination battery interface 46 should be understood as examples. It is also conceivable for more than two different combination battery interfaces 46 for different voltage classes U_{Cl,n} and/or power classes to be used on the electrical device 10. On an electrical device operated at 72 V, for example, it is thus possible to provide a combination battery interface for a 72 V exchangeable battery pack and two 36 V exchangeable battery packs as well as two further combination battery interfaces for a respective 36 V exchangeable battery pack and two 18 V exchangeable battery packs.

What is claimed is:

1. An electrical device comprising:
a control or regulating circuit; and
a plurality of electromechanical battery interfaces configured to supply the electrical device with a maximum permissible operating voltage using at least one exchangeable battery pack,
wherein the at least one exchangeable battery pack is releasably accommodated by the plurality of electromechanical battery interfaces,
wherein the electromechanical battery interfaces are configured to accomodate exchangeable battery packs of at least two different voltage classes, and
wherein the control or regulating circuit of the electrical device is configured to electrically connect several exchangeable battery packs of a lower voltage class in series and/or in parallel such that a resulting battery voltage does not exceed the maximum permissible supply voltage.

2. The electrical device according to claim 1, wherein the control or regulating circuit is configured to connect a plurality of the exchangeable battery packs of a highest possible voltage class in parallel.

3. The electrical device according to claim 1, wherein the control or regulating circuit is configured to control a plurality of the exchangeable battery packs of a highest possible voltage class sequentially or alternately such that only one of the exchangeable battery packs provides energy to the battery-operated device at any given time.

4. The electrical device according to claim 1, wherein the control or regulating circuit is configured to control a plurality of exchangeable battery packs of different voltage classes in a parallel connection sequentially or alternately such that a resulting battery voltage of all exchangeable battery packs of the same voltage class does not exceed the maximum permissible supply voltage.

5. The electrical device according to claim 3, wherein the control or regulating circuit is configured to record a temperature value measured in each exchangeable battery pack and to control the exchangeable battery packs sequentially or alternately as a function of the measured temperature values such that it switches from (i) an exchangeable battery pack the measured temperature value of which exceeds a temperature limit value to (ii) an exchangeable battery pack the measured temperature value of which does not exceed the temperature limit value.

6. The electrical device according to claim 3, wherein the control or regulating circuit is configured to record the battery voltage of each exchangeable battery pack and to control the exchangeable battery packs sequentially or alternately as a function of the measured battery voltages such that it switches from (i) an exchangeable battery pack, the measured battery voltage of which falls below a minimum voltage limit value to (ii) an exchangeable battery pack, the measured battery voltage of which does not fall below the minimum voltage limit value.

7. The electrical device according to claim 3, wherein the control or regulating circuit is configured to control the exchangeable battery packs such that a total power does not fall below a preset minimum power for the battery-operated device.

8. The electrical device according to claim 1, wherein the control or regulating circuit is configured to block the battery-operated device when a resulting battery voltage of all possible connection variations of the exchangeable battery pack falls below a minimum voltage limit value.

9. The electrical device according to claim 5, further comprising:
a display configured to display the exchangeable battery packs currently being controlled, the measured temperature values, and/or battery voltages thereof.

10. The electrical device according to claim 1, wherein the plurality of electromechanical battery interfaces includes (i) at least two electromechanical battery interfaces for exchangeable battery packs of the highest possible voltage class, and (ii) at least two electromechanical battery interfaces for exchangeable battery packs of the lower voltage class.

11. The electrical device according to claim 1, wherein:
the plurality of electromechanical battery interfaces includes at least two combination battery interfaces, and
a first combination interface consists of a plurality of the electromechanical battery interfaces for exchangeable battery packs of at least two different voltage classes such that exchangeable battery packs of different voltage classes cannot be accommodated in it at the same time.

12. The electrical device according to claim 1, wherein:
the exchangeable battery packs of a highest possible voltage class are 36 V exchangeable battery packs, and
the exchangeable battery packs of the lower voltage classes are 18 V and/or 12 V exchangeable battery packs.
